(19) United States
(12) Patent Application Publication
(10) Pub. No.: US 2011/0203544 A1
(43) Pub. Date: Aug. 25, 2011

(54) PISTON FOR INTERNAL COMBUSTION ENGINE

(75) Inventor: Yuuichi Katou, Sizuoka-ken (JP)

(73) Assignee: TOYOTA JIDOSHA KABUSHIKI KAISHA, TOYOTA-SHI (JP)

(21) Appl. No.: 12/673,275

(22) PCT Filed: Aug. 12, 2008
(86) PCT No.: PCT/IB08/02124

§ 371 Date: Feb. 12, 2010

(30) Foreign Application Priority Data
Aug. 13, 2007 (JP) 2007-210812

(51) Int. Cl. F02F 3/00

(52) U.S. Cl. 123/193.6

(57) ABSTRACT

A piston (1) includes a cavity (5) defined by a curved recessed portion (5a) formed on a crown surface in a manner such that a surface of the curved recessed portion extends along a tumble flow produced during an intake stroke, and a weakening portion (6) that is disposed in the cavity. The weakening portion, for example, is disposed on the crown surface of the piston (1) so as to occupy the portion of the crown surface that includes substantially a center portion of the piston (1). The weakening portion (6) reduces the strength of tumble flow produced by the gas flowing into a combustion chamber when the intake valves are opened.

### BACKGROUND OF THE INVENTION

1. Field of the Invention

The invention relates to a piston used in an internal combustion engine, and particularly relates to the configuration of a crown surface of the piston.

2. Description of the Related Art

With regard to internal combustion engines, an internal combustion engine has been proposed in which a top surface of a piston has a pair of substantially symmetric peak portions with a center portion of the piston interposed between the pair of peak portions as described in Japanese Patent Application Publication No. 10-8968 (JP-A-10-8968). Each of the peak portions has a ridgeline that extends in a direction parallel to an axial direction of a crankshaft. Further, a recessed portion is formed on the top surface of the piston by a cylindrically curved surface whose center axis arranged in parallel to the axial direction of the crankshaft. A radius of curvature R of the cylindrically curved surface of the recessed portion is set to one-half of a bore diameter B.

Further, Japanese Patent Application Publication No. 2001-98947 (JP-A-2001-98947) describes the configuration of a piston in which a cavity combustion chamber is provided in a center portion of a crown surface of a piston so as to extend from the intake valve side to the exhaust valve side, and a sectional shape of the cavity combustion chamber has a large radius of curvature R2 in the intake valve side and a small radius of curvature R1 in the exhaust valve side.

A tumble flow is produced in each cylinder of an internal combustion engine. However, a distribution of strength of the tumble flow in the cylinder tends to be non-uniform. More specifically, the speed of flow of the air sucked through the intake valve tends to be fast around the center portion of a combustion chamber, and tends to be slow near a bore wall: Therefore, the distribution of the strength of the tumble flow tends to be non-uniform, and if the distribution of the strength of the tumble flow is non-uniform, the air and fuel do not mix well, so that the air-fuel mixture becomes inhomogeneous. Accordingly, desired effects intended by producing the tumble flow cannot be achieved, resulting in making it difficult to improve combustion. Further, it is not possible to sufficiently solve such problem even by the inventions described in JP-A-10-8968 and JP-A-2001-98947.

### SUMMARY OF THE INVENTION

The invention provides a piston for an internal combustion engine in which strength of a tumble flow is made uniform and the uniformity of an air-fuel mixture is therefore improved.

A piston for an internal combustion engine according to a first aspect of the invention includes: a cavity defined by a curved recessed portion formed on a crown surface in a manner such that a surface of the curved recessed portion extends along a tumble flow produced during an intake stroke; and a weakening portion that is disposed in the cavity and reduces a strength of at least a part of the tumble flow. With this configuration, it is possible to make the strength of the tumble flow (that is, strength of turbulence) in the combustion chamber more uniform, and as a result, it is possible to produce more homogeneous air-fuel mixture and thus facilitate improvement of combustion.

The weakening portion provided on the piston for an internal combustion engine may be disposed in the portion of the recessed portion in which the strength of the tumble flow is stronger than the strength of the tumble flow in a surrounding portion. If the piston is not provided with the weakening portion, the strength of the tumble flow in the combustion chamber differs depending on positions in the combustion chamber. For example, when two intake valves are provided for each cylinder, the strength of the tumble flow produced by the gas taken in when the intake valves are opened is in some cases strong in the area where the gas flows from the two intake valves are merged. In this way, depending on the arrangement of the intake valves and the direction in which the intake valves are arranged, the distribution of the strength of the tumble flow in the combustion chamber becomes sometimes non-uniform. In other words, the strength of the tumble flow varies depending on the positions in the combustion chamber. Therefore, in consideration of such distribution of the strength of the tumble flow, if to the weakening portion is provided in a portion where the tumble flow is stronger (that may be simply referred to as “strong-flow portion”) than its surrounding portion, the strength of the tumble flow in the strong-flow portion is reduced, thereby reducing the difference in the strength between the strong-flow portion and its surrounding portion. Accordingly, it is possible to make the strength of the tumble flow in the combustion chamber more uniform.

In the piston according to the aspect described above, the weakening portion may include a weakening surface whose radius of curvature is larger than a radius of curvature of the recessed portion. When the tumble flow hits the weakening surface, the strength of the tumble flow is reduced. Accordingly, it is possible to make the strength of the tumble flow that hits the weakening portion closer to the strength of the tumble flow around the weakening portion. The weakening portion may include a flat surface. The weakening portion may be formed as a projection.

The weakening portion provided on the crown surface of the piston may be configured in a manner such that the effect of reducing the strength of the tumble flow is strong. The weakening portion may include a weakening surface whose radius of curvature is smaller than a radius of curvature of the recessed portion, and a length from the edge of the weakening surface on the intake valve side to the edge of the weakening surface on the exhaust valve side may differ between a center portion of the weakening portion and the peripheral portion of the weakening portion that is distant from the center portion in the axial direction of a crankshaft.

In consideration of the desired effect as described above, the length from the edge of the weakening surface on the intake valve side to the edge of the weakening surface on the exhaust valve side may be longer in the center portion than in the peripheral portion.

Further, the weakening portion may have the weakening surface that has a circular shape, or the weakening surface that is elliptically shaped. If the to weakening surface has a circular shape, the length in the center portion is longer than the length in the peripheral portion. If the weakening surface is elliptically shaped, the arrangement of the short axis and the long axis of the elliptical weakening surface may be appropriately determined.

Further, the weakening portion may be formed as a projection in the recessed portion. In this case, a top surface of the weakening portion is more gradually and smoothly connected to the recessed portion in the peripheral portion, compared to the center portion. For example, an angle formed between a sidewall of the weakening portion and the top surface of the weakening portion may be set larger in the peripheral portion than in the center portion. Alternatively, a connection portion that connects between a sidewall of the weakening portion and the recessed portion may be rounded, and a radius of curvature of the connection portion may be increased from the center portion to the peripheral portion.

Further, the weakening portion may be configured to be a recess in the recessed portion, and configured so that a depth of the weakening portion becomes shallower in the peripheral portion than in the center portion. It is conceivable that when the weakening portion is formed to be a recess, the deeper the depth of the weakening portion is, the stronger the effect of reducing the strength of the tumble flow by virtue of, for example, separation of the tumble flow is. Therefore, the depth of the weakening portion in the center portion may be set deeper than in the peripheral portion so as to strengthen the effect of reducing the strength of the tumble flow in the center portion.

Further, the weakening portion may be formed as a recess in the recessed portion, a bottom surface of the weakening portion may be more gradually and smoothly connected to the recessed portion in the peripheral portion, compared to the center portion. For example, an angle formed between a sidewall of the recessed portion and the bottom surface of the weakening portion may be larger in the peripheral portion than in the center portion. Alternatively, a connection portion that connects between the sidewall of the recessed portion and the bottom surface of the weakening portion may be rounded in the peripheral portion, and a radius of curvature of the connection portion may be increased from the center portion to the peripheral portion.

Further, the radius of curvature of the recessed portion in which the weakening portion is provided may be changed. For example, the radius of curvature of the recessed portion may be larger in the peripheral portion than in the center portion. With this configuration, it is possible to make the strength of the tumble flow in the combustion chamber more uniform.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1A is an explanatory top view of a cylinder head;

FIG. 1B is an explanatory side view of the cylinder head;

FIG. 1C is an explanatory diagram showing the cylinder head when viewed in the direction indicated by the arrow A in FIG. 1A;

FIG. 2 is an explanatory diagram showing a distribution of strength of a tumble flow in a combustion chamber when a piston is not provided with a weakening portion;

FIG. 3 is a perspective view showing a piston according to a first embodiment;

FIG. 4 is a sectional view taken along the line IV-IV in FIG. 3;

FIG. 5 is a sectional view taken along the line V-V in FIG. 3;

FIG. 6A is a plan view of the piston according to the first embodiment;

FIG. 6B is a sectional view taken along the line VIB-VIB in FIG. 6A;

FIG. 6C is a sectional view taken along the line VIC-VIC in FIG. 6A;

FIG. 6D is a sectional view taken along the line VID-VID in FIG. 6A;

FIG. 7A is an explanatory diagram showing the distribution of the strength of the tumble flow when a piston is not provided with the weakening portion;

FIG. 7B is an explanatory diagram showing the distribution of the strength of the tumble flow when a piston is provided with the weakening portion;

FIG. 8A is a plan view of a modification example of the piston according to the first embodiment;

FIG. 8B is a sectional view taken along the line VIIIB-VIIIB in FIG. 8A;

FIG. 8C is a sectional view taken along the line VIIIC-VIIIC in FIG. 8A;

FIG. 8D is a sectional view taken along the line VIIID-VIIID in FIG. 8A;

FIG. 9A is a plan view of a piston according to a second embodiment;

FIG. 9B is a sectional view taken along the line IXB-IXB in FIG. 9A;

FIG. 9C is a sectional view taken along the line IXC-IXC in FIG. 9A;

FIG. 9D is a sectional view taken along the line IXD-IXD in FIG. 9A;

FIG. 10 is an enlarged view showing a region X in FIG. 9B;

FIG. 11 is an enlarged view showing a region Y in FIG. 9C;

FIG. 12A is a plan view of a piston according to a third embodiment;

FIG. 12B is a sectional view taken along the line XIIB-XIIB in FIG. 12A;

FIG. 12C is a sectional view taken along the line XIIC-XIIC in FIG. 12A;

FIG. 12D is a sectional view taken along the line XIID-XIID in FIG. 12A;

FIG. 13 is an explanatory diagram showing a region Z in FIG. 12C enlarged;

FIG. 14 is an explanatory diagram showing a portion around a sidewall of a recessed weakening portion enlarged;

FIG. 15 is a plan view of a piston according to a first modification example of the third embodiment; and

FIG. 16 is a plan view of a piston according to a second modification example of the third embodiment.

### DETAILED DESC PTION OF THE EXAMPLE EMBODIMENTS

Embodiments of the invention will be described in detail below with reference to the attached drawings.

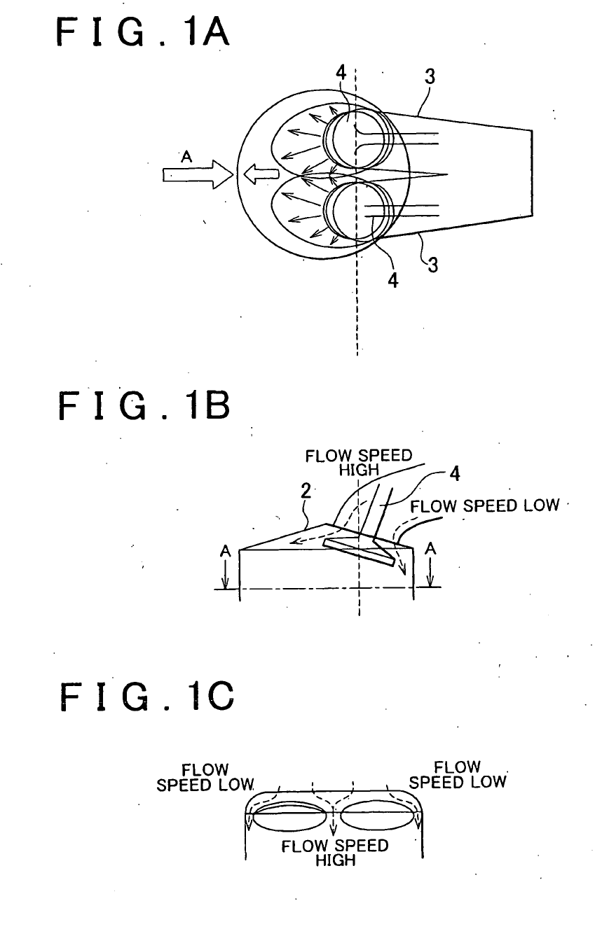

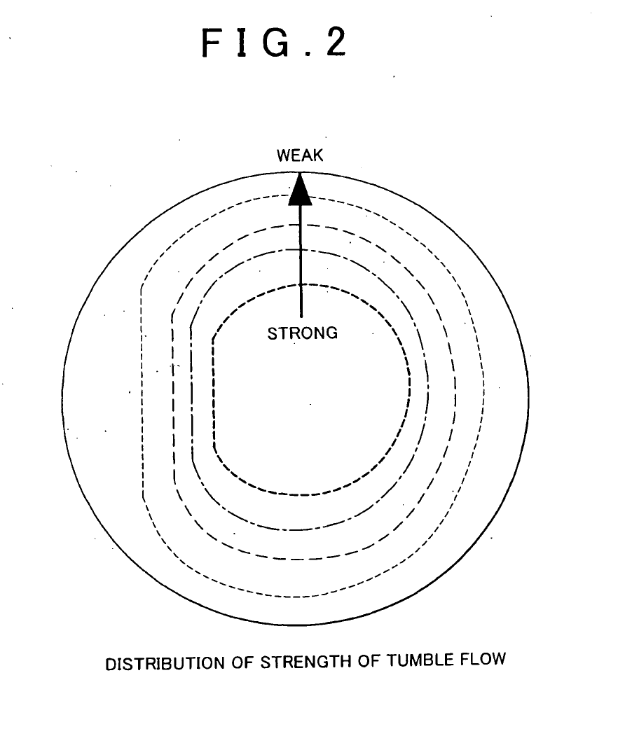

First, a configuration around a combustion chamber in an internal combustion engine in which a piston 1 for an internal combustion engine (hereinafter simply referred to as “piston 1”) according to a first embodiment of the invention is installed will be described with reference to FIGS. 1A to 1C. FIG. 1A is an explanatory top view of a cylinder head 2, FIG. 1B is an explanatory side view of the cylinder head 2, and FIG. 1C is an explanatory diagram showing the cylinder head 2 when viewed in the direction indicated by the arrow A in FIG. 1A. It should be noted that exhaust valves are omitted from the drawings in order to simplify the explanation of the configuration. The cylinder head 2 includes two intake ports 3, each of which is fitted with an intake valve 4. In the configuration in which the intake ports 3 (that is, the intake valves 4) are arranged side by side, a strength of tumble flow becomes stronger between the intake valves 4, that is, in the area near a center portion of the combustion chamber. More specifically, the speed of flow of intake gas is faster around the center portion of the combustion chamber in which the airflows from the intake ports 3, which are arranged side by side, are merged, and thus, in the center portion, the strength of the tumble flow tends to be strong. FIG. 2 roughly shows the distribution of the strength of the tumble flow. As is evident from FIG. 2, the strength of the tumble flow becomes strongest in the center portion of the combustion chamber, and the strength of the tumble flow is gradually decreased from the center portion to a portion near a bore wall of the cylinder.

The piston 1 according to the first embodiment is disposed in each of the cylinders in which the tumble flow as described above is produced, and makes the distribution of the strength of the tumble flow in the cylinder uniform. Next, a configuration of a crown surface of such a piston will be described.

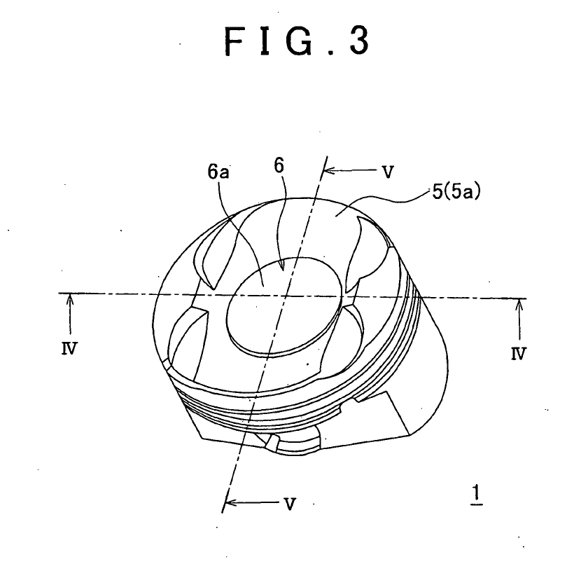

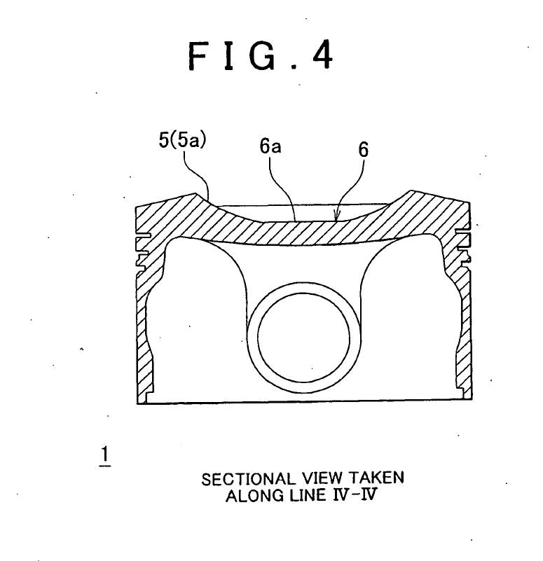

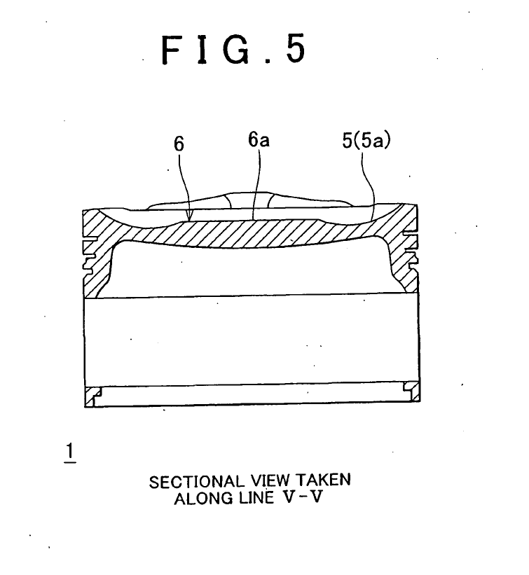

FIG. 3 is a perspective view showing the piston 1 according to the first o embodiment. FIG. 4 is a sectional view taken along the line IV-IV in FIG. 3. FIG. 5 is a sectional view taken along the line V-V in FIG. 3. The piston 1 is disposed in a manner such that the direction along the line V-V is along the axial direction of a crankshaft. FIG. 6A is a plan view of the piston 1. FIGS. 6B, 6C, 6D are explanatory sectional views of the piston 1 taken along the lines VIB-VIB, VIC-VIC, VID-VID shown in FIG. 6A, respectively.

The piston 1 includes a cavity 5 defined by a curved recessed portion 5a. The recessed portion 5a is formed on the crown surface so that the surface of the curved recessed portion 5a extends along the tumble flow produced during the intake stroke. The cavity 5 is formed in a manner such that a longitudinal direction of the cavity 5 is set along the axial direction of the crankshaft. As shown in the FIGS. 6A to 6D, two intake-side recesses 7 and two exhaust-side recesses 8 for preventing the intake and exhaust valves from interfering with the piston 1 are provided next to the cavity 5. The radius of curvature of the curved recessed portion 5a differs depending on positions in the recessed portion 5a. More specifically, a radius of curvature R2 in a portion distant from a center portion of the recessed portion 5a is larger than a radius of curvature R1 in the center portion of the recessed portion 5a.

A weakening portion 6 is provided in the cavity 5 thus configured. The weakening portion 6 is disposed so as to occupy a portion of the crown surface of the piston 1, the portion including a center portion of the crown surface. The weakening portion 6 reduces the strength of the tumble flow produced by the gas flowing into the combustion chamber when the intake valves 4 are opened. The distribution of the strength of the tumble flow varies depending on the arrangement of the intake valves 4 and the direction in which the intake valves 4 are arranged and therefore, the arrangement of the weakening portion 6 may be appropriately changed. The strength of the tumble flow tends to be strong in the center portion of the combustion chamber, and gradually decreased from the center portion to a portion near the bore wall. Therefore, the weakening portion provided on the crown surface of the piston is preferably configured in a manner such that the effect of reducing the strength of the tumble flow is strong in the center portion of the combustion chamber. In the first embodiment, the weakening portion 6 is disposed in the portion of the crown surface of the piston 1, the portion including the center portion of the crown surface where the strength of the tumble flow is stronger than its surrounding portion as described above.

A weakening surface 6a, which is a top surface of the weakening portion 6, is formed to be a circular, flat surface as shown in FIG. 6A. The tumble flow that is produced by the gas aspirated when the intake valves 4 are opened hits the weakening surface 6A. It is preferable that the weakening surface 6a have a larger radius of curvature than that of the recessed portion 5a. This is because if the weakening surface 6a has a larger radius of curvature than that of the recessed portion 5a, the strength of the tumble flow is further effectively reduced. In the first embodiment, the weakening surface 6a is formed to be flat, that is, the radius of curvature thereof is infinity (the curvature is zero). The weakening surface 6a has a circular shape, and the length of the weakening surface 6 from the edge of the weakening surface 6a on the intake valve side (hereinafter referred to as “IN side” as shown in the drawing) to the edge on the exhaust valve side (hereinafter referred to as “EX side” as shown in the drawing) therefore differs between the center portion of the weakening surface 6a and the portions distant from the center portion. More specifically, when comparing the length of the flat surface in the sectional view taken along the line VIB-VIB in FIG. 6B with the length of the flat surface in the sectional view taken along the line VIC-VIC in FIG. 6C, the length of the flat surface in the sectional view taken along the line VIB-VIB is longer. It is conceivable that the greater length of the flat surface exhibits the greater effect of reducing the strength of the tumble flow. Thus, the weakening surface 6a is therefore configured to exhibit a stronger effect of reducing the strength of the tumble flow in the center portion where the strength of the tumble flow is relatively strong.

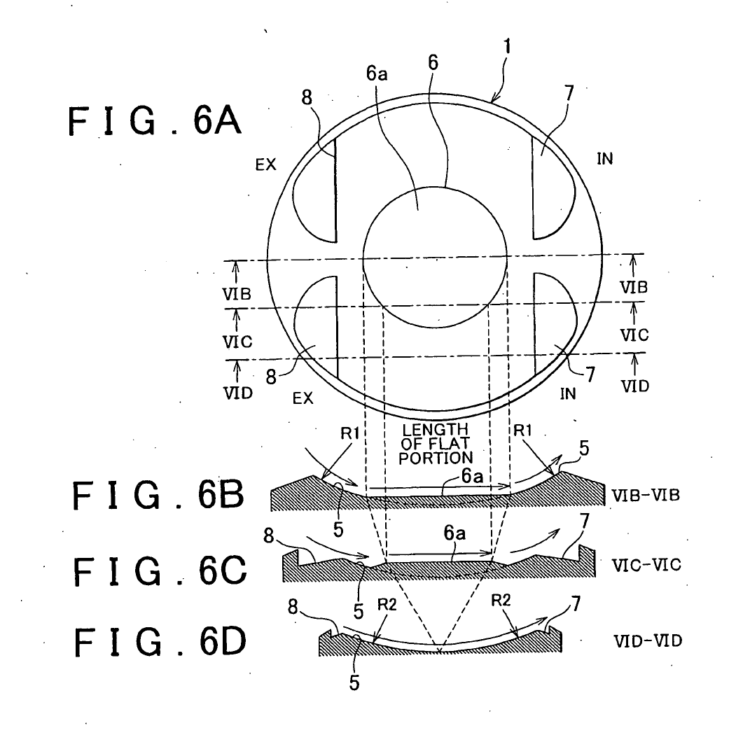

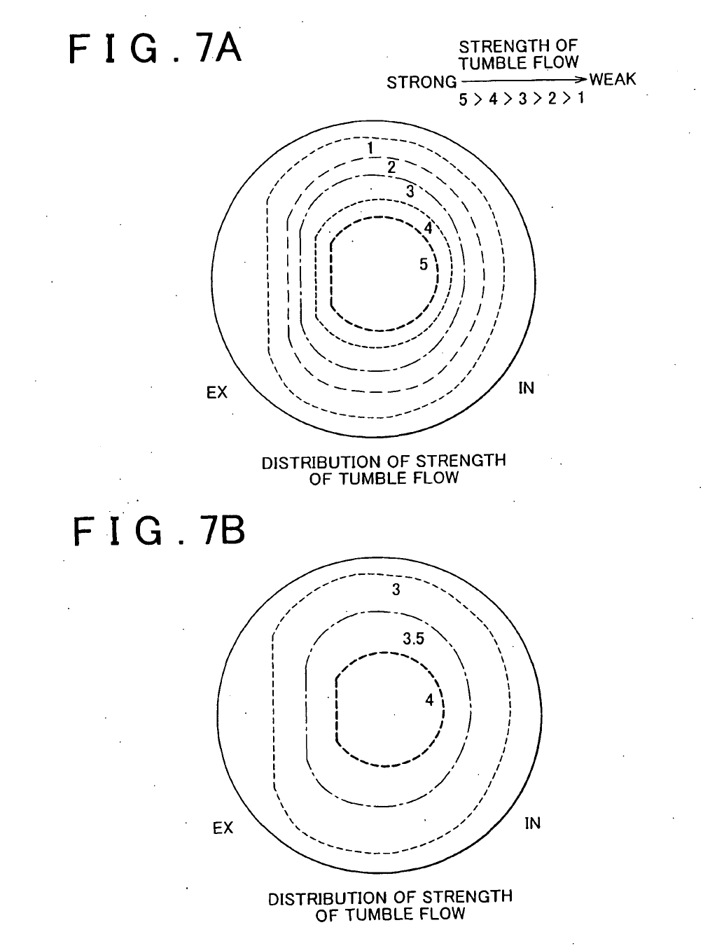

The effect of reducing and uniforming the strength of the tumble flow that the thus-configured piston 1 exhibits will be described with reference to FIGS. 7A and 7B. FIG. 7A shows the distribution of the strength of the tumble flow when a piston is not provided with the weakening portion 6. FIG. 7B shows the distribution of the strength of the tumble flow for the piston 1 according to the first embodiment on which the weakening portion 6 is provided. It should be noted that the distribution of the strength of the tumble flow is shown in five levels of the strength, and the numerals in the drawing represent not the absolute values of the strength but the relative scale of the strength. Therefore, the evaluation “3” in FIG. 7A may be different in terms of the absolute value of the strength of the tumble flow from the evaluation “3” in FIG. 7B. As shown in FIG. 7A, with regard to the distribution of the strength of the tumble flow when the weakening portion 6 is not provided on the piston; the strength of the tumble flow over the center portion of the piston is “5”, the strength is gradually decreased from the center portion to a peripheral portion of the piston, and the strength of the tumble flow over the peripheral portion is “1”. In other words, the distribution of the strength is relatively wide. On the other hand, with regard to the distribution of the strength of the tumble flow when the piston 1 according to the first embodiment is used, the strength of the tumble flow over the center portion of the piston 1 is “4”, and the strength of the tumble flow over the peripheral portion of the piston_1 is “3”. This indicates that the distribution of the strength of the tumble flow in the cylinder is made more uniform. When the distribution of the strength of the tumble flow is made more uniform in this way, the air and fuel is mixed well to form homogeneous air-fuel mixture, thereby facilitating improvement of combustion. As a result, it is possible to, for example, set the air-fuel ratio (A/F) to be leaner and perform a control to retard the ignition timing, and as a result, it is possible to reduce emission.

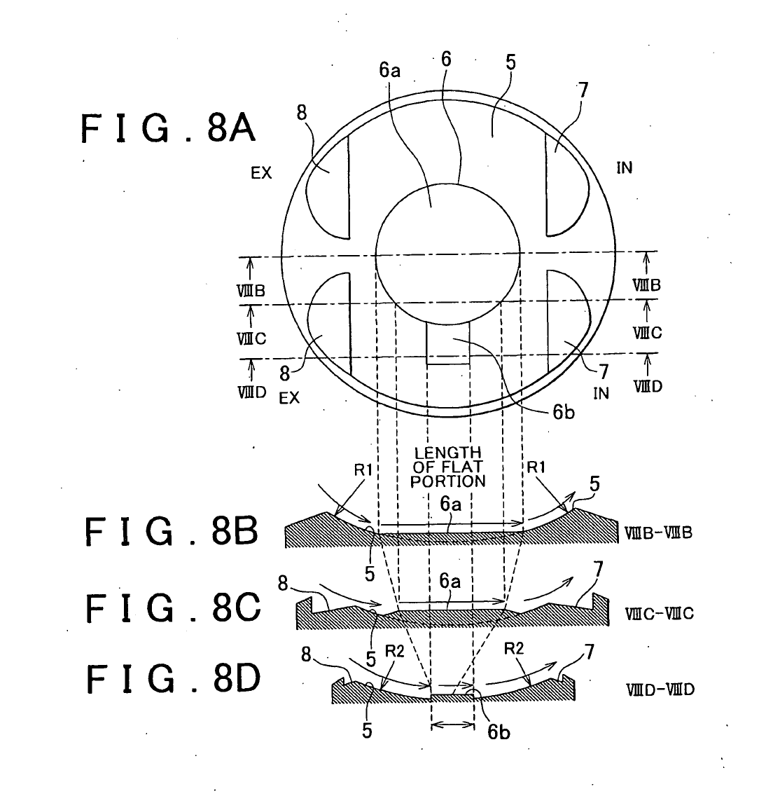

As described above, the weakening portion 6 according to the first embodiment impedes the tumble flow and reduces the strength of the tumble flow in accordance with the strength of the tumble flow, that is, more strongly in the area in which the strength of the tumble flow is stronger. The configuration and size of the weakening portion 6 may be modified as appropriate so as to achieve desired reduction of the strength of the tumble flow. Therefore, the configuration shown in FIG. 8A may be employed. More specifically, an extension portion 6b may be provided to extend from the weakening portion 6 in the axial direction of the crankshaft so that the strength of the tumble flow is reduced even in the portion distant from the center portion of the weakening portion 6. The extension portion 6b functions as a tuning element whose configuration and size can be modified depending on the desired reduction of the strength of the tumble flow.

The weakening surface 6a preferably has a larger radius of curvature than that of the recessed portion 5a. However, the weakening surface 6a may have a smaller radius of curvature than that of the recessed portion 5a.

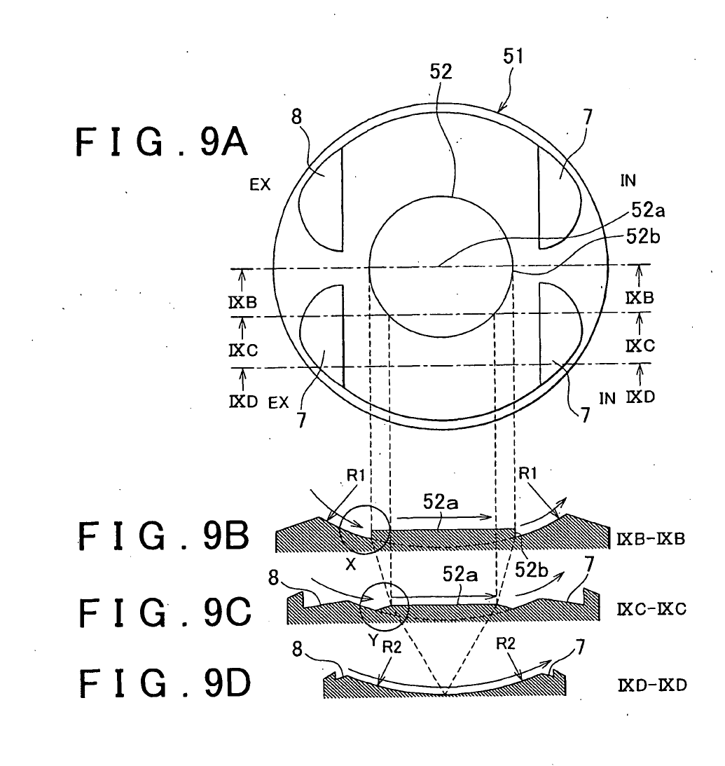

Next, a second embodiment of the invention will be described with reference to FIGS. 9 to 11. A piston 51 according to the second embodiment differs from the piston 1 according to the first embodiment in the following point. That is, the weakening portion 6 of the piston 1 according to the first embodiment is not stepped from the recessed portion 5a as shown in the sectional view taken along the line VIB-VIB in FIG. 6B. On the other hand, in the piston 51 according to the second embodiment, a weakening portion 52 is formed as a projection in the recessed portion 5a. FIG. 9A is a plan view of the piston 51, and FIGS. 9B, 9C, 9D are explanatory sectional views of the piston 51 taken along the lines IXB-IXB, IXC-IXC, IXD-IXD shown in FIG. 9A. As is evident from the sectional view taken along the line IXB-IXB, the weakening portion 52 includes a stepped connection portion. The connection portion connects between the recessed portion 5a and a weakening surface 52a, which forms a top surface of the weakening portion 52. In this configuration, when the tumble flow in the cylinder collides with the weakening portion 52, the strength of the tumble flow is effectively reduced.

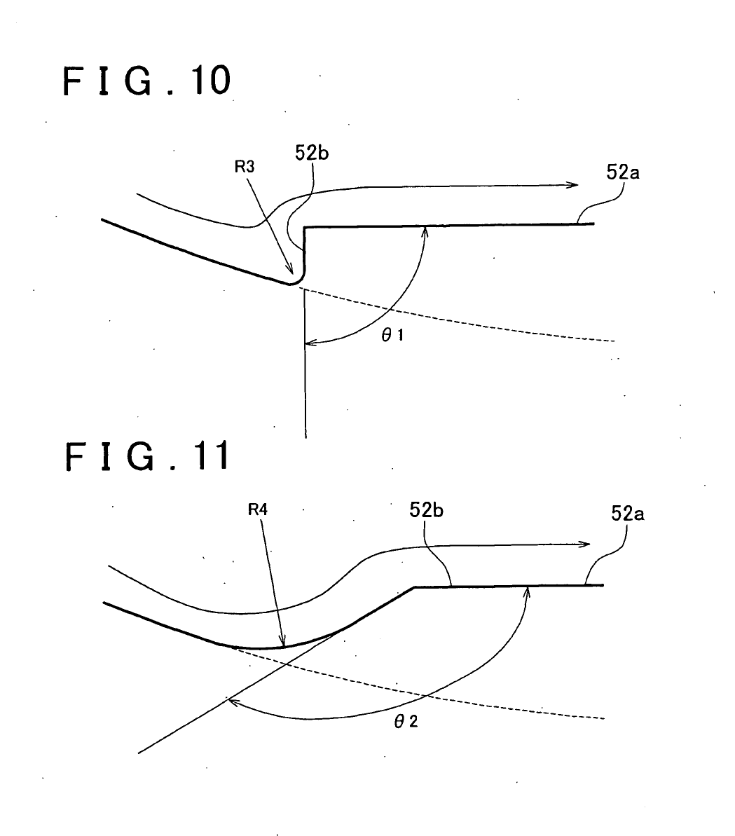

The weakening surface 52a (top surface) of the weakening portion 52 is more gradually and smoothly connected to the recessed portion 5a in a portion distant from the center portion of the weakening portion 52, compared to the center portion of the weakening portion 52. FIG. 10 is an explanatory enlarged view showing a region X in FIG. 9B, that is, the connection portion that connects between a sidewall surface 52b of the weakening portion 52 and the recessed portion 5a in the center portion of the piston 51. Further, FIG. 11 is an explanatory enlarged view showing a region Y in FIG. 9C, that is, the connection portion that connects between the sidewall surface 52b of the weakening portion 52 and the recessed portion 5a in the portion distant from the center portion of the piston 51. The connection portion that connects between the recessed portion 5a and the sidewall surface 52b of the weakening portion 52 in the center portion (shown in the sectional view taken along the line IXB-IXB) of the piston 51 is curved at a radius of curvature R3, and the angle formed between the weakening surface 52a and the sidewall surface 52b is set to θ1. On the other hand, the connection portion that connects between the recessed portion 5a and the sidewall surface 52b of the weakening portion 52 in the portion distant from the center portion (shown in the sectional view taken along the line IXC-IXC) of the piston 51 is curved at a radius of curvature R4, and the angle formed between the weakening surface 52a and the sidewall surface 52b is set to 02. The relation between the radius of curvature R3 and the radius of curvature R4 is R3<R4, and the relation between θ1 and θ2 is θ1<θ2. In other words, the connection portion is formed to provide a smoother connection in the portion distant from the center portion of the piston 51, as compared to the connection portion in the center portion. In this configuration, the reduction effect on the strength of the tumble flow is strong in the center portion of the piston 51, and is weak in the portion distant from the center portion. As a result, it is possible to make the distribution of the strength of the tumble flow in the cylinder more uniform.

Further, other structural elements in the configuration of the piston 51 are the same as the corresponding structural elements in the configuration of the piston 1 according to the first embodiment. Therefore, the corresponding structural elements are denoted by the same reference numerals in the drawings, and the detailed description thereof will be omitted.

A modification of the second embodiment may be configured so that the connection portion that connects between the recessed portion 5a and the sidewall surface 52b of the weakening portion 52 in the center portion of the piston 51 (shown in the sectional view taken along the line IXB-IXB) is not rounded, and only the connection portion that connects between the recessed portion 5a and the sidewall surface 52b of the weakening portion 52 in the peripheral portion of the piston 51 is rounded. Further, the curvature of the connection portion may be changed in a stepwise manner instead of in a continuous manner.

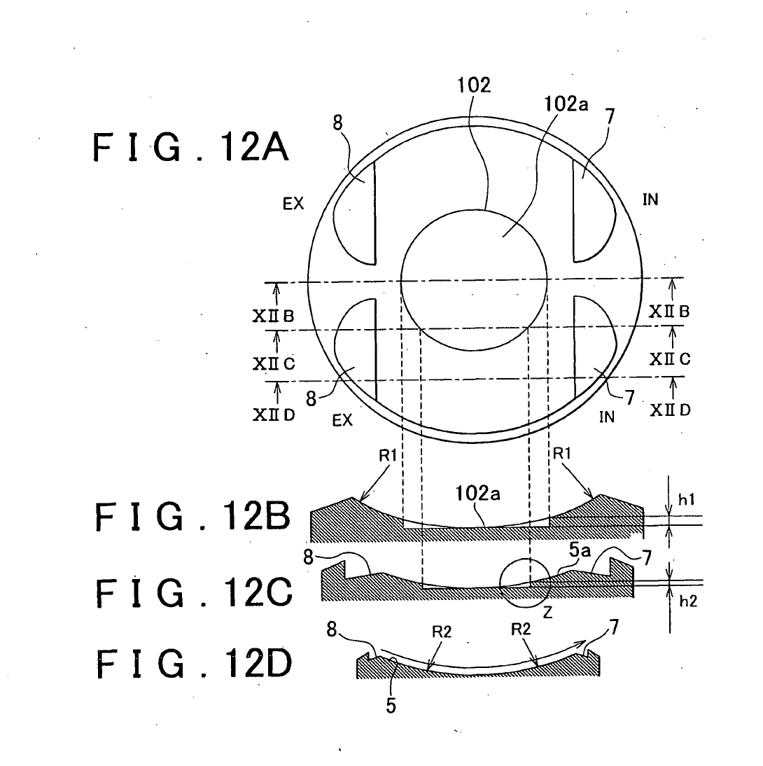

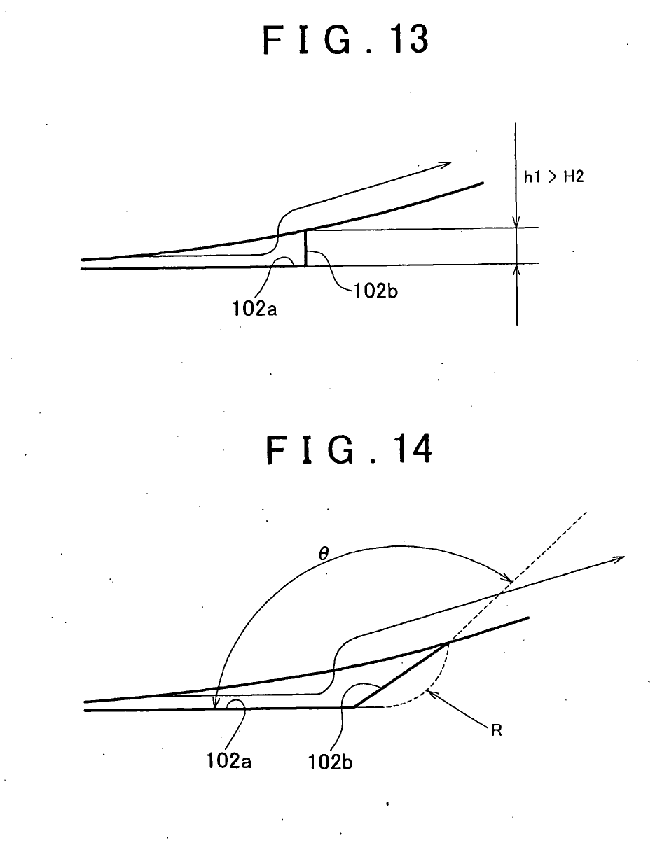

Next, a third embodiment of the invention will be described with reference to FIGS. 12 to 14. A piston 101 according to the third embodiment differs from the piston 1 according to the first embodiment in the following point. That is, the weakening portion 6 of the piston 1 according to the first embodiment is not stepped from the recessed portion 5a as shown in the sectional view taken along the line VIB-VIB in FIG. 6A. On the other hand, in the piston 101, a weakening portion 102 is formed as a recess in the recessed portion 5a. FIG. 12A is a plan view of the piston 101, and FIGS. 12B, 12C, 12D are explanatory sectional views of the piston 101 taken along the lines XIIB-XIIB, XIIC-XIIC, XIID-XIID in FIG. 12A. FIG. 13 is an explanatory diagram showing a region Z in FIG. 12C enlarged, that is, the connection portion that connects between a weakening surface (bottom surface) 102a and the recessed portion 5a in a portion distant from a center portion of the piston 101. A depth h2 of the weakening portion 102 in the portion distant from the center portion of the piston 101 (shown in the sectional view taken along the line XIIC-XIIC) is shallower than a depth h1 of the weakening portion 102 in the center portion of the piston 101 (shown in the sectional view taken along the line XIIB-XIIB). In this configuration, separation of the tumble flow in the portion distant from the center portion is reduced, so that the reduction effect on the strength of the tumble flow is weakened in this portion. On the other hand, the depth of the weakening portion 102 is deep in the center portion of the piston 101, and the separation effect on the tumble flow is accordingly strong. Therefore, the reduction effect on the strength of the tumble flow is also strong. Accordingly, in this configuration, the reduction effect on the strength of the tumble flow is strong in the center portion of the piston 101, and is small in the portion distant from the center portion of the piston 101, whereby it is possible to make the distribution of the strength of the tumble flow more uniform in the cylinder.

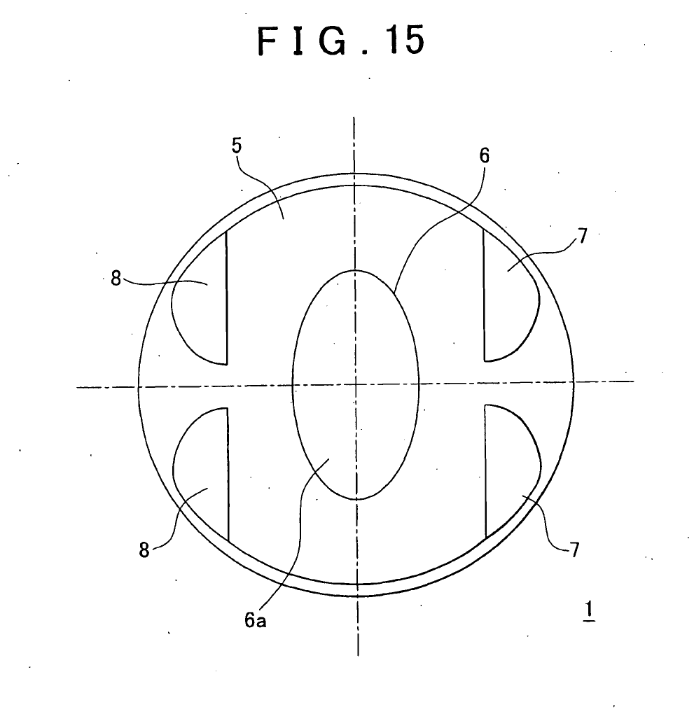

As described above, if the recessed weakening portion 102 is provided in the recessed portion 5a, it is possible to adjust the reduction effect on the strength of the tumble flow by changing an angle 0 shown in FIG. 14, that is, the angle θ formed between the sidewall 102b and the weakening surface 102a of the sidewall 102b of the recessed weakening portion 102. If the angle θ is set large, separation of the tumble flow near the sidewall 102b is suppressed, so that the reduction effect on the strength of the tumble flow is weakened in the portion distant from the center portion of the piston 101. As a result, in addition to the weakening of the effect to reduce the strength, the strength of the tumble flow in the center portion of the piston 101 is reduced, and it is possible to make the distribution of the strength of the tumble flow in the cylinder more uniform.

Further, the sidewall 102b may be curved so that the reduction effect on the strength of the tumble flow is adjusted by changing a roundness R of the curved sidewall 102b. More specifically, if the radius R of the curved sidewall 102b is set larger so that the tumble flow is produced along the curved sidewall 102b so as to suppress separation of the tumble flow, it is possible to weaken the reduction effect on the strength of the tumble flow in the portion distant from the center portion of the piston 101. As a result, in addition to the weakening of the effect to reduce the strength, the strength of the tumble flow in the center portion of the piston 101 is reduced, and it is possible to make the distribution of the strength of the tumble flow in the cylinder more uniform.

While the invention has been described with reference to exemplary embodiments thereof, it should be understood that the invention is not limited to the exemplary embodiments or constructions. To the contrary, the invention is intended to cover various modifications and equivalent arrangements. It is apparent that the invention can be implemented in various other embodiments within the scope of the invention. The weakening portion provided for the piston according to the invention may have any configuration as long as it is possible to reduce the strength of the tumble flow. For example, a configuration may be adopted in which the portion of the crown surface of the piston that the strong tumble flow hits has a rougher surface than its surrounding portion.

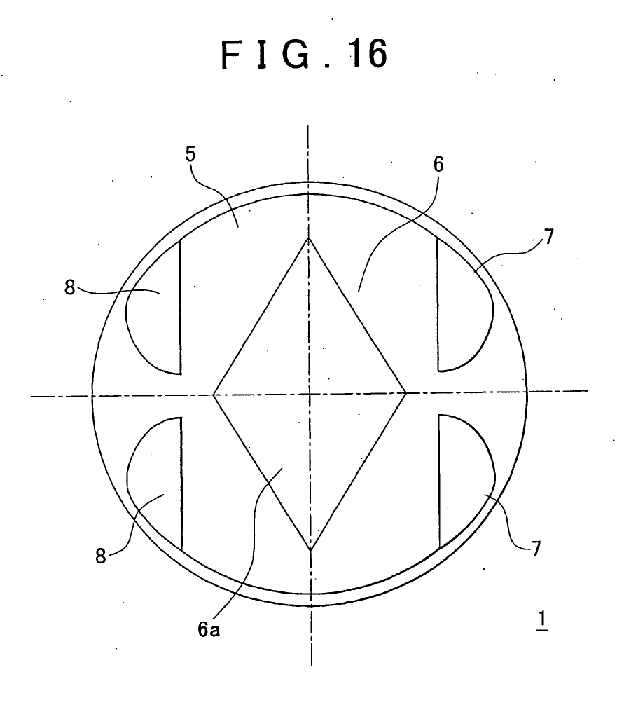

Further, the weakening portion may be configured so that the length from the edge of the weakening portion on the intake valve side to the edge on the exhaust valve side is longer in the center portion of the weakening surface than the corresponding length in the portion distant from the center portion. For example, the weakening portion may be configured as shown in FIG. 15, that is, the weakening portion 6 may be configured to have an elliptically shaped weakening surface 6a. Further, as shown in FIG. 16, the weakening portion 6 may be configured to have a rhombus-shaped weakening surface 6a.

1. A piston for an internal combustion engine, comprising:
a cavity defined by a curved recessed portion formed on a crown surface in a manner such that a surface of the curved recessed portion extends along a tumble flow produced during an intake stroke, the curved recessed portion being formed along the tumble flow that flows from an intake port to an exhaust port; and
a weakening portion that is disposed in the cavity and reduces a strength of at least a part of the tumble flow.

2. The piston according to claim 1, wherein
the weakening portion is disposed in a portion of the recessed portion in which the strength of the tumble flow is stronger than the strength of the tumble flow in a surrounding portion.

3. The piston according to claim 1, wherein
the weakening portion includes a weakening surface whose radius of curvature is larger than a radius of curvature of the recessed portion.

4. The piston according to claim 1, wherein
the weakening portion includes a weakening surface whose radius of curvature is smaller than a radius of curvature of the recessed portion.

5. The piston according to claim 1, wherein
the weakening portion has a flat surface.

6. The piston according to claim 3, wherein
a length from an edge of the weakening surface on an intake valve side to an edge of the weakening surface on an exhaust valve side differs between a center portion of the weakening portion and a peripheral portion of the weakening portion that is distant from the center portion in an axial direction of a crankshaft.

7. The piston according to claim 6, wherein
the length from the edge of the weakening surface on the intake valve side to the edge of the weakening surface on the exhaust valve side is longer in the center portion than in the peripheral portion.

8. The piston according to claim 1, wherein
the weakening portion has a weakening surface that has a circular shape.

9. The piston according to claim 1, wherein
the weakening portion has a weakening surface that is elliptically shaped.

10. The piston according to claim 1, wherein
the weakening portion is formed as a projection in the recessed portion.

11. The piston according to claim 10, wherein:
a top surface of the weakening portion is more gradually and smoothly connected to the recessed portion in a peripheral portion of the weakening portion, compared to a center portion of the weakening portion; and
the peripheral portion is distant from the center portion in an axial direction of a crankshaft.

12. The piston according to claim 11, wherein
an angle formed between a sidewall of the weakening portion and the top surface of the weakening portion is larger in the peripheral portion than in the center portion.

13. The piston according to claim 11, wherein
a connection portion that connects between a sidewall of the weakening portion and the recessed portion is rounded in the peripheral portion.

14. The piston according to claim 13, wherein
a radius of curvature of the connection portion is increased from the center portion to the peripheral portion.

15. The piston according to claim 1, wherein
the weakening portion is formed as a recess in the recessed portion,
a depth of the weakening portion becomes shallower in a peripheral portion of the weakening portion than in a center portion of the weakening portion; and
the peripheral portion is distant from the center portion in an axial direction of a crankshaft.

16. The piston according to claim 1, wherein:
the weakening portion is formed as a recess in the recessed portion,
a bottom surface of the weakening portion is more gradually and smoothly connected to the recessed portion in a peripheral portion of the weakening portion, compared to a center portion of the weakening portion; and
the peripheral portion is distant from the center portion in an axial direction of a crankshaft.

17. The piston according to claim 16, wherein
an angle formed between a sidewall of the recessed portion and the bottom surface of the weakening portion is larger in the peripheral portion than in the center portion.

18. The piston according to claim 17, wherein
a connection portion that connects between the sidewall of the recessed portion and the bottom surface of the weakening portion is rounded in the peripheral portion.

19. The piston according to claim 18, wherein
a radius of curvature of the connection portion is increased from the center portion to the peripheral portion.

20. The piston according to claim 1, wherein
the radius of curvature of the recessed portion is larger in a peripheral portion of the weakening portion than in a center portion of the weakening portion; and
the peripheral portion is distant from the center portion in an axial direction of a crankshaft.

21. A piston for an internal combustion engine according to claim 1, wherein at least one intake-side recess and at least one exhaust-side recess for preventing an intake valve and an exhaust valve from interfering with the piston are provided next to the cavity, and the curved recessed portion is formed in the whole area surrounded by the intake-side recess and the exhaust-side recess.

22. A piston for an internal combustion engine according to claim 1, wherein at least one intake-side recess and one exhaust-side recess for preventing an intake valve and an exhaust valve from interfering with the piston are provided next to the cavity and an outer edge of the curved recessed portion connects an outer edge of the intake-side recess with an outer edge of the exhaust-side recess.
